(19) United States
(12) Patent Application Publication
(10) Pub. No.: US 2024/0062049 A1
(43) Pub. Date: Feb. 22, 2024

(54) METHOD AND APPARATUS WITH MODEL TRAINING

(71) Applicant: SAMSUNG ELECTRONICS CO., LTD., Suwon-si (KR)

(72) Inventors: Yujie ZENG, Xi'an (CN); Wenlong HE, Xi’an (CN); Lin CHEN, Xi’an (CN); Ihor VASYLTSOV, Suwon-si (KR)

(73) Assignee: SAMSUNG ELECTRONICS CO., LTD., Suwon-si (KR)

(21) Appl. No.: 18/355,619

(22) Filed: Jul. 20, 2023

(30) Foreign Application Priority Data
Aug. 15, 2022 (CN) 202210975061.4
Apr. 24, 2023 (KR) 10-2023-0053236

(51) Int. Cl. G06N 3/047; G06N 3/08

(52) U.S. Cl. CPC G06N 3/047; G06N 3/08

(57) ABSTRACT

A processor implemented method including iteratively training a model through repeated training operations, including calculating a respective sensitivity of each layer of plural layers included in the model, the model including a machine-learning model, calculating a first maintenance probability for a t-th repeated training of the model, calculating a respective maintenance probability of each of the plural layers of the model based on the respective sensitivity of each of the plural layers and based on the first maintenance probability for the t-th repeated training of the model, and performing the t-th repeated training of the model including training selected one or more maintenance layers, of the plural layers of the model, whose respective maintenance probabilities satisfy a first predetermined maintenance condition.

### CROSS-REFERENCE TO RELATED APPLICATIONS

This application claims the benefit under 35 USC § 119(a) of Chinese Patent Application No. 202210975061.4, filed on Aug. 15, 2022, in the China National Intellectual Property Administration, and Korean Patent Application No. 10-2023-0053236, filed on Apr. 24, 2023, in the Korean Intellectual Property Office, the entire disclosures of which are incorporated herein by reference for all purposes.

### BACKGROUND

### 1. Field The following description relates to a method and apparatus with model training.

### 2. Description of Related Art

Typically, a machine-learning model, such as an artificial intelligence (AI) neural network, may be used in a natural language processing (NLP) model such as a transformer model. The transformer model may be trained for tasks including question answering (QA), emotion analysis, information extraction, image caption, and the like using data such as text, images, voice, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including iteratively training a model through repeated training operations, including calculating a respective sensitivity of each layer of plural layers included in the model, the model including a machine-learning model, calculating a first maintenance probability for a t-th repeated training of the model, calculating a respective maintenance probability of each of the plural layers of the model based on the respective sensitivity of each of the plural layers and based on the first maintenance probability for the t-th repeated training of the model, and performing the t-th repeated training of the model including training selected one or more maintenance layers, of the plural layers of the model, whose respective maintenance probabilities satisfy a first predetermined maintenance condition.

In the calculating of the respective sensitivity of each layer included in the model, a corresponding sensitivity of an l-th layer is calculated based on an accuracy of the model resulting from the plural layers being trained a predetermined number of times and an accuracy of the model resulting from the less than the plural layers, with training of the 1-th layer being skipped, trained a corresponding predetermined number of times, and “l” is a positive integer and has a value not greater than a number of layers of the model.

The first maintenance probability of the t-th repeated training of the model is calculated based on a related parameter of the model, a training repetition ordinal number “t,” and a predetermined maintenance probability, and “t” is a positive integer.

The method may include determining each first layer, of the plural layers, whose respective sensitivity satisfy a predetermined sensitivity condition as a maintained layer, or the one or more maintenance layers, that is to be maintained for each of the plural repeated trainings and determining a second layer, of the plural layers, whose respective sensitivity a second predetermined sensitivity condition as a skipped layer for which training is to be skipped in each of the plural repeated trainings.

The calculating of the respective maintenance probability of each of the plural layers may include calculating respective maintenance probabilities of each of one or more layers of the plural layers, other than the one or more maintenance layers and the skipped layer, for the t-th repeated training of the machine-learning model and setting the respective maintenance probability of each of the one or more maintenance layers a maintenance probability value that satisfies the first predetermined maintenance condition.

The calculating of the respective maintenance probability of each of the plural layers of the model may include calculating a calibration factor of the t-th repeated training of the model, based on a current throughput of the model and the first maintenance probability of the t-th repeated training of the model and calculating the respective maintenance probability of each of the plural layers of the model based on the respective sensitivity of each of the plural layers of the model, the first maintenance probability of the t-th repeated training of the model, and the calibration factor of the t-th repeated training of the model.

The calculating of the respective maintenance probability of each of the plural layers of the model further may include calculating the first maintenance probability of the t-th repeated training of the model in accordance with

$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ ,$$

and
where θₜ is the first maintenance probability of the t-th repeated training of the model, a is a shape parameter of the model, b is a proportional parameter of the model, c is a binomial weight of the model, t is a training repetition ordinal number, ε is a threshold parameter of the model, η is an amplification factor of the model, θ is a predetermined maintenance probability, and Γ is a gamma function.

The calculating of the respective maintenance probability of each of the plural layers of the model, based on the respective sensitivity of each of the plural layers of the model, the maintenance probability of the t-th repeated training of the model, and the calibration factor for the t-th repeated training of the model includes calculating the respective maintenance probability of each of the plural layers of the model in accordance with

p_{t,l}=clamp(αₜ(θₜ+βS_{base}(l)), θₘᵢₙ, θₘₐₓ), and

where p_{t,l} is the respective maintenance probability of an l-th layer for the t-th repeated training of the model, αₜ is the calibration factor for the t-th repeated training of the model, θₜ is the first maintenance probability for the t-th repeated training of the model, β is a sensitivity factor, S_{base}(l) is sensitivity of the l-th layer of the model, θₘᵢₙ is a minimum value for the respective maintenance probability of the l-th layer of the t-th repeated training of the model, and θₘₐₓ is a maximum value of the respective maintenance probability of the l-th layer for the t-th repeated training of the model.

The calculating of the calibration factor for the t-th repeated training of the model, based on the current throughput of the model and the first maintenance probability for the t-th repeated training of the model includes calculating the calibration factor for the t-th repeated training of the model in accordance with

$${α}_{t} = 2 - ( \frac{T {P}_{c u r r}}{{θ}_{t} + x - {θ}_{t} * x} ) ,$$

and
where αₜ is the calibration factor of the t-th repeated training of the model, TP_{curr} is the current throughput of the model, θₜ is the first maintenance probability for the t-th repeated training of the model, and x is a predetermined throughput improvement goal.

The method may include determining whether an experiment result of a Bernoulli distribution including a respective third maintenance probability of each layer as a parameter is “1” and determining a one or more layers having a Bernoulli distribution value corresponding to “1” as a maintenance layer of the one or more maintenance layers.

In a general aspect here is provided an electronic apparatus including a processor configured to calculate a respective sensitivity of each layer included in a model, calculate a first maintenance probability for a t-th repeated training of the model, calculate a respective maintenance probability of each of plural layers of the model based on the respective sensitivity of each of the plural layers and based on the first maintenance probability for the t-th repeated training of the model, and perform the t-th repeated training of the model including training selected one or more maintenance layers, of the plural layers of the model, whose respective maintenance probabilities satisfy a first predetermined maintenance condition.

For the calculating of the respective sensitivity, the processor may be configured to calculate sensitivity of an l-th layer based on a first accuracy of the model resulting from the plural layers being trained a predetermined number of times and an accuracy of the model resulting from the less than the plural layers, with training of the 1-th layers being skipped, being trained a corresponding predetermined number of times, and “l” is a positive integer and not greater than a number of layers of the model.

The processor, for the calculating of the first maintenance probability, may be configured to calculate the first maintenance probability of a t-th repeated training of the model based on a related parameter of the model, a training repetition ordinal number “t,” and a predetermined maintenance probability, and “t” is a positive integer.

For the calculation of the respective sensitivities, the processor may be configured to determine each first layer, of the plural layers, whose respective sensitivity satisfy a predetermined sensitivity condition as a maintained layer, of the one or more maintenance layers, that is to be maintained for each of plural repeated trainings and determine a second layer whose respective sensitivity satisfies a second predetermined sensitivity condition as a skipped layer for which training is to be skipped in each of the plural repeated trainings.

For the calculation of the respective maintenance probability, the processor is configured to calculate the respective maintenance probabilities of each of one or more layers of the plural layers, other than the one or more maintenance layers and the skipped layer, for the t-th repeated training of the model and set the respective maintenance probability of each of the maintenance layers, a maintenance probability value that satisfies the first predetermined maintenance condition.

For the calculating of the respective maintenance probability, the processor is configured to calculate a calibration factor of the t-th repeated training of the model, based on a current throughput of the model and the first maintenance probability and calculate the respective maintenance probability of each of the plural layers of the model based on the respective sensitivity of each layer of the model, the first maintenance probability of the t-th repeated training of the model, and the calibration factor of the t-th repeated training of the model.

The processor may be configured to, for the calculation of the maintenance probability of the t-th repeated training of the model, calculate the maintenance probability of the t-th repeated training of the model in accordance with

$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ ,$$

and
where θₜ is the first maintenance probability, a is a shape parameter of the model, b is a proportional parameter of the model, c is a binomial weight of the model, t is a training repetition ordinal number, ε is a threshold parameter of the model, η is an amplification factor of the model, θ is a predetermined maintenance probability, and Γ is a gamma function.

The processor may be configured to calculate the maintenance probability of each of the plural layers of the model in accordance with

p_{t,l}=clamp(αₜ(θₜ+βS_{base}(l)), θₘᵢₙ, θₘᵢₙ), and

p_{t,l} is the respective maintenance probability, αₜ is the calibration factor for the t-th repeated training of the model, θₜ is the first maintenance probability, β is a sensitivity factor, S_{base}(l) is sensitivity of the l-th layer of the model, θₘᵢₙ is a minimum value for the respective maintenance probability, and θₘₐₓ is a maximum value of the respective maintenance probability.

The processor may be configured to determine whether an experiment result of a Bernoulli distribution including a respective third maintenance probability of each layer as a parameter is “1” and determine one or more layers having a Bernoulli distribution value corresponding to “1” as a maintenance layer of the one or more maintenance layers.

In a general aspect, here is provided a processor-implemented method including determining, from among a plurality of layers of a machine-learning model, one or more layers having a sensitivity below a predetermined threshold according to a probability for a t-^{th} repeated training of the machine-learning model, iteratively training the machine-learning model as t-^{th} repeated training, including skipping training of the one or more layers having the sensitivity below the predetermined threshold, and training the machine-learning model according to remaining layers, other than the one or more layers whose training is skipped in the t-^{th} repeated training, having sensitivities above the predetermined threshold.

Other features and aspects will be apparent from the following detailed description, the drawings, and the claims.

### BRIEF DESCRIPTION OF THE DRAWINGS

FIG. 1 illustrates an example method according to one or more embodiments.

FIG. 2 illustrates an example method of layer skipping with a blacklist group and a whitelist group according to one or more embodiments.

FIG. 3 illustrates an example method with model training according to one or more embodiments.

FIG. 4 illustrates an example model training apparatus according to one or more embodiments.

FIG. 5 illustrates an example electronic device to provide model training according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Typically, large-scale AI neural network such as generative pre-trained transformer 3 (GPT-3) may be capable of achieving good performance in many NLP tasks. In an example, the performance improves as the size of the AI neural network increases. However, long-term unsupervised pre-training of the large-scale AI neural network may require a significant amount of computing resources and considerable training time. To achieve higher model accuracy, longer training time and more hardware resources may be required and thus more costs may be incurred.

Typical solutions using the large-scale AI neural network such as GPT-3 may have disadvantages of lower accuracy and weak generalization ability.

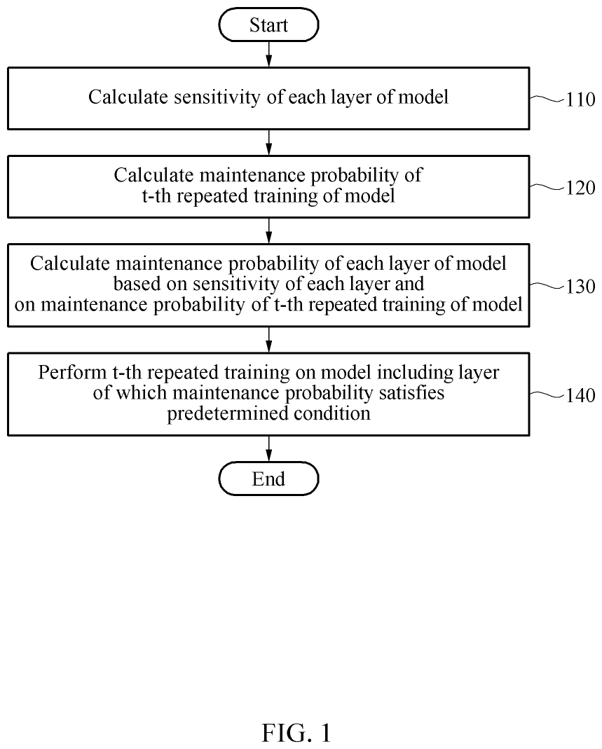

FIG. 1 illustrates an example method according to one or more embodiments.

Referring to FIG. 1, in a non-limiting example, in operation 110, the method may calculate sensitivity of each layer of a machine-learning model, such as a neural network.

In operation 110, in an example, a sensitivity of the first layer may be calculated based on an accuracy of a machine-learning model that has been trained a predetermined number of times and an accuracy of the model that has been trained a corresponding predetermined number of time (e.g., the predetermined number of times) that includes skipping training of the l-th layer. In an example, “l” may be a positive integer and not greater than the number of layers of the machine-learning model (i.e., a model).

In an example, a generation of the sensitivity of each layer of the model may be used to statically measure an importance of each layer while training to ensure that the accuracy is not lost when skipping a training of one or more of the layers.

In a non-limiting example, the accuracy of the model may be the accuracy of the model after training the predetermined number of times of repeated iterative training. Nonetheless, in an example, a skipping a training of one or more layers (i.e., the first layer) of the model does not affect accuracy of model, and that, after training the predetermined number of times of repeated training, does not include, or omits, the accuracy of the first layer when training of the layer is skipped during the predetermined number of times.

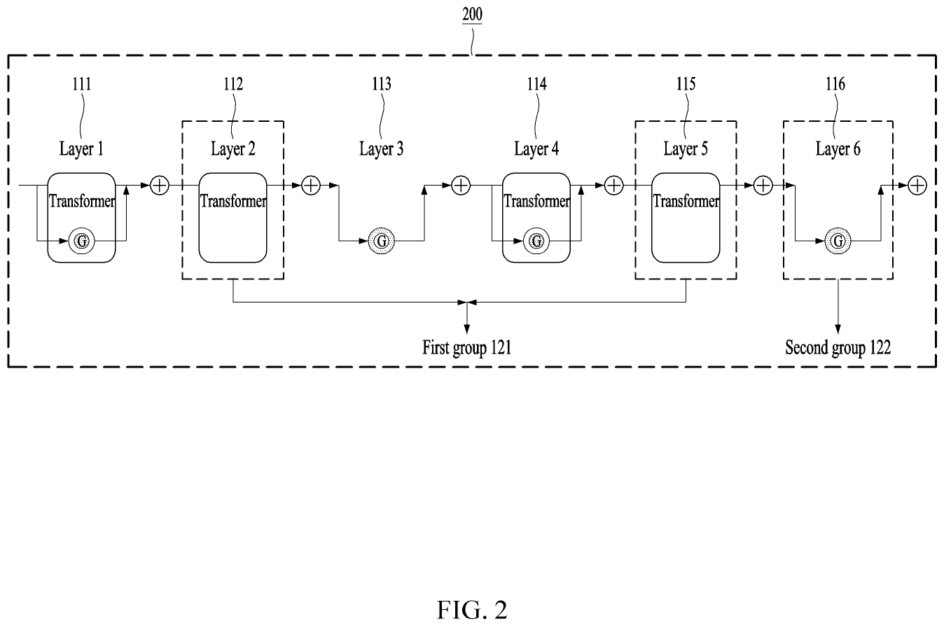

FIG. 2 illustrates an example method of layer skipping with a blacklist group and a whitelist group illustrated according to one or more embodiments.

Referring to FIG. 2, in a non-limiting example, a machine-learning model 200 may be configured to include a plurality of layers (layer 1 111, layer 2 112, layer 3 113, layer 4 114, layer 5 115, and layer 6 116). Here, in one training operation of an example training of the machine learning model 200, a blacklist group (a first group 121), which includes a high-sensitivity layer, may be trained and the training may skip training of a whitelist group (a second group 122), which includes a low-sensitivity layer, but the present disclosure may not be limited thereto. As a non-limiting example, when the maintenance probability of the whitelist group is a small probability value such as “0.1,” it may be possible for the whitelist group to be maintained in the current repeated training, and thus, the blacklist and whitelist groups may both be trained in the corresponding repeated training.

Referring to FIG. 1, in operation 120, a method of training the machine-learning model may include calculating the maintenance probability for the t-th repeated training of the model.

In operation 120, the maintenance probability for the t-th repeated training of the model may be calculated based on a related parameter of the model, a training repetition ordinal number “t,” and a predetermined maintenance probability. Here, the “t” is a positive integer.

In an example, a model training method may reduce the negative effect of skip layer calculation on the overall training accuracy by fitting the effect of a skipped training layer on a model convergence in a training time dimension and determining a training repetition maintenance probability using a parameter related to a layer of the skipped training of the model.

For example, the parameter related to the model may be one of a shape parameter, a proportional parameter, a binomial weight, an amplification factor, a threshold parameter, and the like of the model, and any combination thereof.

In an example, the repetition maintenance probability may be calculated according to the equations below.

$$IF ( t ) = \frac{{2}^{( a + c )}}{Γ ( a + c ) {b}^{( a + c )}} {( t - ε )}^{( a + c - 1 )} {e}^{( - 2 * \frac{t - ε}{b} )}$$

In Equation 1, IF(t) is an influencing factor, a is the shape parameter of the model, b is the proportional parameter of the model, c is the binomial weight of the model, t is the training repetition ordinal number, ε is the threshold parameter of the model, Γ is a gamma function, and e is an exponential function.

$${θ}_{t} = \frac{η}{{θ}^{2}} IF ( t ) + θ$$

In Equation 2, θₜ is the maintenance probability for the t-th repeated training of the model, IF(t) is an influencing factor, η is the amplification factor of the model, and θ is the predetermined maintenance probability, which, in an example, may be predetermined or variously set (e.g., by a person skilled in the art according to a desired goal). Here, θ may be set within a range of “0.4”˜“1” and the range of θ may, in an example, be predetermined or variously changed (e.g., by a person skilled in the art according to a desired goal).

Thus, Equation 3 below may be obtained by combining Equation 1 and Equation 2.

$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ$$

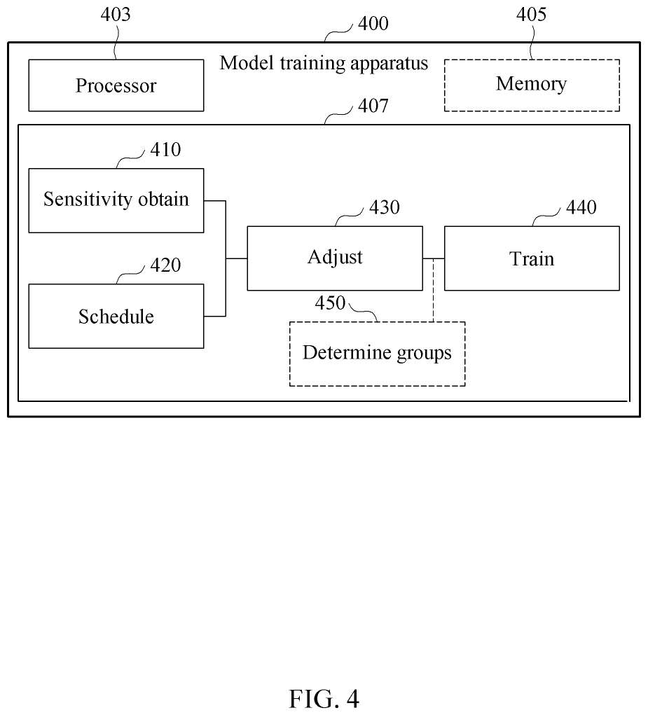

In an example, Equation 3 may simulate the effect of skipping the training of a layer on a model convergence in a training time dimension. In an example, the maintenance probability for the t-th repeated training may be calculated based on Equation 3. Equation 3 is discussed in greater detail below with respect to FIG. 4.

Referring to FIG. 1, in a non-limiting example, in operation 130, the model training method may calculate the maintenance probability of each layer of the model based on the sensitivity of each layer included in the model and on the maintenance probability of the t-th repeated training of the model.

In an example, in operation 130, the maintenance probability may be calculated for each of layers, other than the layer whose training is to be maintained in each of plural repeated training, and calculated for the layer whose training is to be skipped for each of the plural repeated training, i.e., in the t-th repeated training of the model. In operation 130, the maintenance probability of the layer whose training is to be maintained in each of the plural repeated training may be calculated (e.g., set) as a maintenance probability value that satisfies a predetermined condition.

In an example, the layer to be maintained (i.e., whose training is to be performed in the repeated training) for each repeated training may be a layer of which a sensitivity value satisfies the first predetermined condition in operations described below, after operation 110.

In an example, the maintenance probability of each layer of the model, that is, the maintenance probability of each of the layers of the model other than the layer to be maintained for each repeated training and the layer to be skipped for each repeated training, may be more accurately obtained by introducing the throughput of the model. More specifically, the calibration factor of the t-th repeated training of the model may be calculated based on a current throughput of the model and the maintenance probability of the t-th repeated training of the model. The maintenance probability of each layer of the model may be calculated based on one or more of the sensitivity of each layer of the model, the maintenance probability of the t-th repeated training of the model, and the calibration factor of the t-th repeated training of the model.

In an example, maintenance probability of each layer of the model may be calculated and obtained according to the equations shown below.

$${α}_{t} = 2 - ( \frac{T {P}_{curr}}{{θ}_{t} + x - {θ}_{t} * x} )$$

In Equation 4, αₜ is the calibration factor of the t-th repeated training of the model, TP_{curr} is the current throughput of the model, x is a predetermined throughput improvement goal, and θₜ is the maintenance probability of the t-th repeated training of the model determined in operation 120.

p_{t,l}=clamp(αₜ(θₜ+βS_{base}(l)), θₘᵢₙ, θₘₐₓ) Equation 5

In Equation 5, p_{t,l} is the maintenance probability of an l-th layer of the t-th repeated training of the model, αₜ is the calibration factor of the t-th repeated training of the model, β is a sensitivity factor, S_{base}(l) is sensitivity of the l-th layer of the model, θₘᵢₙ is a minimum value of the maintenance probability of the l-th layer of the t-th repeated training of the model, and θₘₐₓ is a maximum value of the maintenance probability of the l-th layer of the t-th repeated training of the model. Here, θₘᵢₙ may be set to “0.4” and θₘₐₓ may be set to “1”, in an example, but are not limited thereto, and may have various values. For example, a person skilled in the art may choose or change the setting according to a desired goal.

In an example, the maintenance probability of each layer may also be obtained through Equation 6, shown below, without limiting an upper limit and a lower limit.

p_{t,l}=αₜ(θₜ+βS_{base}(l)) Equation 6

In an example, the maintenance probability of each layer may also be obtained through Equation 7, shown below, in a situation in which the calibration factor αₜ is not considered.

p_{t,l}=θₜ+βS_{base}(l) Equation 7

Referring to FIG. 1, in an example, in operation 140, the model training method may perform the t-th repeated training on the model including a layer of which a maintenance probability satisfies the predetermined condition.

More specifically, in operation 140, the model training method may determine whether an experiment result of a Bernoulli distribution with a maintenance probability of each layer as a parameter is “1” and may determine a layer corresponding to “1” as a layer of which the maintenance probability satisfies the predetermined condition.

In an example, in operation 110, regarding training a model through a determined number of training repetitions with a current layer having a skip probability of a third value and another layer having a skip probability of a fourth value, whether an experiment result of a Bernoulli distribution with a maintenance probability of the current layer or the other layer as a parameter is “1” may be determined first. When the corresponding experiment result of the Bernoulli distribution is “0,” the corresponding layer may be skipped. When the corresponding experiment result of the Bernoulli distribution is “1,” the corresponding layer may be maintained.

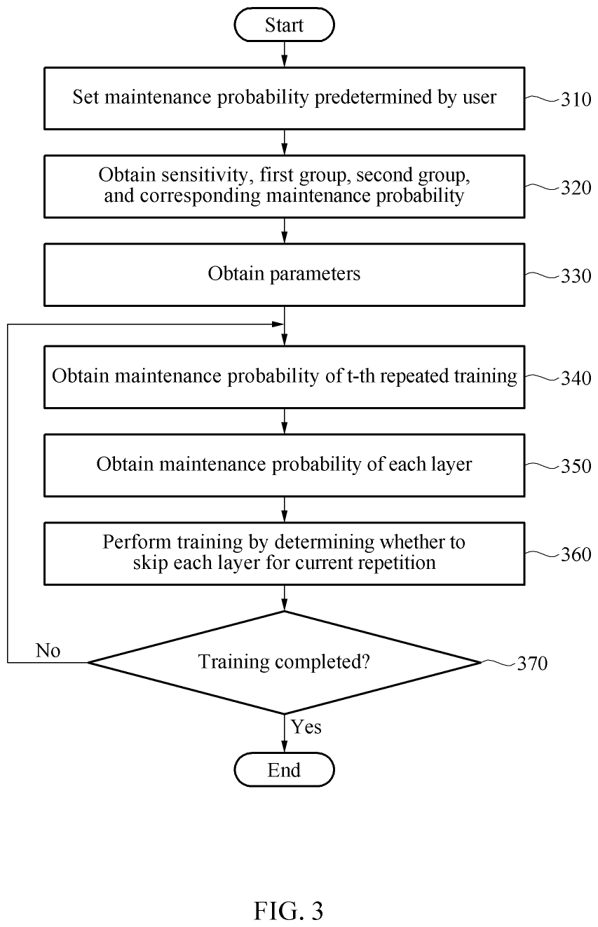

FIG. 3 illustrates an example method with model training according to one or more embodiments.

Referring to FIG. 3, in a non-limiting example, in operation 310, the model training method may first set a maintenance probability (e.g., predetermined by a user). In operation 320, the model training method may obtain sensitivity, a first group, a second group, and a corresponding maintenance probability through the model.

In operation 330, the model training method may obtain parameters including one or more of a shape parameter, a proportional parameter, a binomial weight, an amplification factor, a threshold parameter, and a throughput improvement goal of the model.

In operation 340, the model training method may obtain the maintenance probability of the current training repetition (t-th training repetition) of the model.

In operation 350, the model training method may additionally obtain the maintenance probability of each layer. In operation 360, the model training method may perform training by determining whether to skip each layer for the current training repetition.

That is, in an example, the model training method may use a first value as the maintenance probability when a layer is in the first group, may use a second value as the maintenance probability when the layer is in the second group, and may use the maintenance probability of the corresponding layer obtained based on the throughput when the layer is not in the first group or the second group. Subsequently, the model training method may determine whether to skip the layer during the current training repetition based on an experiment result of a Bernoulli distribution with the maintenance probability of the layer as a parameter. That is, in an example, the layer may be skipped during the current training repetition when the experiment result of the Bernoulli distribution with the maintenance probability of the layer as a parameter is “0” and the layer may be maintained when the experiment result of the Bernoulli distribution with the maintenance probability of the layer as a parameter is “1.”

In operation 370, the model training method may check whether the performance of training for the current training repetition is complete. When it is confirmed that the training is not completed, the model training method may proceed back to operation 340 and repeat operations 340 to 370 until the training is completed.

The flowchart illustrated in FIG. 3 and its order is only an example and is not limited thereto. In an example, the order of each step may be adjusted according to a desired value. In an example, a user may obtain the sensitivity, the first group, the second group, and the corresponding maintenance probability (operation 320) and subsequently set the predetermined maintenance probability (operation 310). In an example, in the case of a training repetition, the model training method may complete a calculation of the calibration factor and a maintenance probability of all layers before the training repetition, may calculate the calibration factor and the maintenance probability of a layer, and subsequently perform training of the corresponding layer, or may complete operations for a current layer and subsequently calculate the calibration factor and maintenance probability of a next layer.

In addition, after performing the operations of the repeated training as in FIG. 3, the model training method may, in an example, generate or provide, as feedback, a training loss of the model for subsequent training.

FIG. 4 illustrates an example electronic apparatus.

Referring to FIG. 4, in a non-limiting example, an electronic apparatus (i.e., training apparatus) 400 may include a processor 403, configured to perform operations 407, which may include operations 410-440, respectively, of obtaining a sensitivity , a scheduling, an adjusting, and a training.

The obtaining of the sensitivity in operation 410 may be performed by processor 403 that is configured to calculate sensitivity of each layer of the model. Here, the sensitivity of the l-th layer may be calculated based on accuracy of a model that has been trained a predetermined number of times and the accuracy of a model that has been trained the predetermined number of times while skipping the training of the l-th layer, where “l” may be a positive integer and may not be greater than the number of layers of the model.

In a non-limiting example, the processor 403 may be configured to perform operation 450 of determining a group, including determining a layer of which sensitivity satisfies the first predetermined condition as a layer of a first group (of one or more layers) to be maintained (i.e., that are trained, such as with connection weighting adjustments through back-propagation of a loss through all layers up to the initial maintained layer) for each repeated training and determining a layer of which sensitivity satisfies the second predetermined condition as a layer, for which training is to be skipped for each of the repeated training, based on the sensitivity of each layer.

In an example, the processor 403 may be configured to perform operation 450 classifying a determined number of high-sensitivity layers as the first group and a determined number of low-sensitivity layers as the second group. Here, the maintenance probability of a layer in the first group may be set to the first value and the maintenance probability of a layer in the second group may be set to the second value, which is less than the first value. In an example, the classifying of the layers may be referred to as selecting of the layers.

In an example, the processor 403 may be configured to perform operation 420 including the maintenance probability of the t-th repeated training of the model. Here, the maintenance probability of the t-th repeated training of the model may be calculated based on a related parameter of the model, a training repetition ordinal number “t,” and a predetermined maintenance probability and the “t” may be a positive integer.

In an example, the processor 403 may be configured to obtain the maintenance probability of the t-th repeated training of the model by Equation 3, which is repeated, for ease of reference, below.

$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ$$

In Equation 3, θₜ is the maintenance probability of the t-th repeated training of the model, a is a shape parameter of the model, b is a proportional parameter of the model, c is a binomial weight of the model, t is the training repetition ordinal number, ε is a threshold parameter of the model, Γ is a gamma function, e is an exponential function, and η is an amplification factor of the model.

The The processor 403 may be configured to perform operation 430, including calculating the maintenance probability of each layer of the model based on the sensitivity of each layer and on the maintenance probability of the t-th repeated training of the model.

In an example, the processor 407 may be configured to perform operation 430, including calculating the maintenance probability of each of the layers of the model in the t-th repeated training of the model. Here, the selected layers of the model may be the layers other than the layer to be maintained for each repeated training and the layer to be skipped for each repeated training among all layers of the model. In addition, the processor 403 may be configured to set the maintenance probability of the layer (e.g., a selected layer) to be maintained for each repeated training as a maintenance probability value that satisfies a predetermined condition.

Here, the processor 403 may be configured to obtain the maintenance probability of each layer in the model, that is, the maintenance probability of each layer among the layers of the model other than the selected layer to be maintained for each repeated training and the selected layer to be skipped for each repeated training, based on the throughput of the model. In an example, the processor 403 may be configured to calculate a calibration factor of the t-th repeated training of the model, based on the current throughput of the model and the maintenance probability of the t-th repeated training of the model, and to calculate the maintenance probability of each layer of the model, based on the sensitivity of each layer, the maintenance probability of the t-th repeated training of the model, and the calibration factor.

The processor 403 may be configured to calculate the maintenance probability of each layer of the model by Equation 5, which is repeated below, for ease of reference.

p_{t,l}=clamp(αₜ(θₜ+βS_{base}(l)), θₘᵢₙ, θₘₐₓ) Equation 5

In Equation 5, p_{t,l} is the maintenance probability of an l-th layer of the t-th repeated training of the model, αₜ is the calibration factor of the t-th repeated training of the model, β is a sensitivity factor, S_{base}(l) is sensitivity of the l-th layer of the model, θₘᵢₙ is a minimum value of the maintenance probability of the l-th layer of the t-th repeated training of the model, and θₘₐₓ is a maximum value of the maintenance probability of the l-th layer of the t-th repeated training of the model.

The processor 403 may be configured to calculate the calibration factor by Equation 4, which is also repeated below, for ease of reference.

$${α}_{t} = 2 - ( \frac{T {P}_{curr}}{{θ}_{t} + x - {θ}_{t} * x} )$$

In Equation 4, αₜ is the calibration factor of the t-th repeated training of the model, TP_{curr} is the current throughput of the model, x is a predetermined throughput improvement goal, and θₜ is the maintenance probability of the t-th repeated training of the model.

In an example, the processor 403 may be configured to perform operation 440, including performing the t-th repeated training on the model including a layer of which the maintenance probability satisfies a predetermined condition.

More specifically, the processor 403 may be configured to determine whether an experiment result of a Bernoulli distribution with the maintenance probability of each layer as a parameter is “1” and to determine a layer corresponding to “1” as a layer of which the maintenance probability satisfies the predetermined condition.

In an example, other operations corresponding to operations 410-450 may be similar to the model training method described in greater detail above with reference to FIG. 1 and thus are not repeatedly described here.

The training apparatus 400 may include a memory 405, where the processor 403 is configured to execute instructions and the memory 405 may store the instructions, which when executed by the processor 403 may configure the processor 403 to perform any one or any combination among all operations or methods described herein.

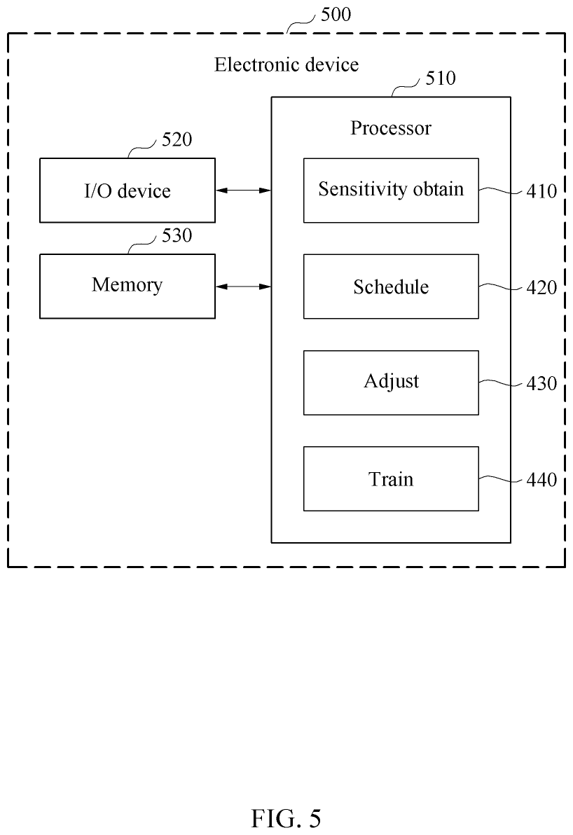

FIG. 5 illustrates an example electronic device to provide model training according to one or more embodiments.

Referring to FIG. 5, in a non-limiting example, an electronic device 500 may include a processor 510, an input/output (I/O) device 520, and a memory 530.

The input/output (I/O) device 520 may receive a user's input to the electronic device 500 and provide the received input to the processor 510. The input/output (I/O) device 520 may include a user interface which may provide the capability of inputting and outputting information regarding a user and an image.

The processor 510 may be configured to execute computer readable instructions to configure the processor 510 to control the electronic apparatus 200 and/or 500, as non-limiting examples, to perform one or more or all operations and/or methods involving the training of neural networks as well as implementation of the trained neural network, and may include any one or a combination of two or more of, for example, a central processing unit (CPU), a graphic processing unit (GPU), a neural processing unit (NPU) and tensor processing units (TPUs), but is not limited to the above-described examples.

The memory 530 may store an operating system (OS), applications or programs, and storage data, which are used and/or generated through the operations of processor 510, as well as needed to control overall operations of the processor 510, and may also store the model and may store the computer-readable instructions. The processor 510 may be configured to execute the computer-readable instructions, such as those stored in the memory 530, and through execution of the computer-readable instructions, the processor 510 is configured to perform one or more, or any combination, of the operations and/or methods described herein. The memory 530 may be a volatile or nonvolatile memory.

The processor 510 may control the overall operations of the electronic device 500. In addition, the processor 510 may perform operations 410-through 440 of FIG. 4.

Description regarding operations 410-440 are given with reference to FIG. 4 and thus detailed descriptions thereof are not repeated here.

The processors, memories, neural networks, electronic apparatuses, electronic apparatus 200, electronic apparatus (i.e., training apparatus) 400, processor 403, memory 405, electronic apparatus 500, processor 510, I/O device 520, and memory 530, described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks , and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
iteratively training a model through repeated training operations, including:
calculating a respective sensitivity of each layer of plural layers included in the model, the model comprising a machine-learning model;
calculating a first maintenance probability for a t-th repeated training of the model;
calculating a respective maintenance probability of each of the plural layers of the model based on the respective sensitivity of each of the plural layers and based on the first maintenance probability for the t-th repeated training of the model; and
performing the t-th repeated training of the model including training selected one or more maintenance layers, of the plural layers of the model, whose respective maintenance probabilities satisfy a first predetermined maintenance condition.

2. The method of claim 1, wherein, in the calculating of the respective sensitivity of each layer included in the model, a corresponding sensitivity of an l-th layer is calculated based on an accuracy of the model resulting from the plural layers being trained a predetermined number of times and an accuracy of the model resulting from less than the plural layers, with training of the 1-th layer being skipped, trained a corresponding predetermined number of times, and
wherein “l” is a positive integer and has a value not greater than a number of layers of the model.

3. The method of claim 1, wherein the first maintenance probability of the t-th repeated training of the model is calculated based on a related parameter of the model, a training repetition ordinal number “t,” and a predetermined maintenance probability, and
wherein “t” is a positive integer.

4. The method of claim 1, further comprising:
determining each first layer, of the plural layers, whose respective sensitivity satisfy a predetermined sensitivity condition as a maintained layer, or the one or more maintenance layers, that is to be maintained for each of plural repeated trainings; and
determining a second layer, of the plural layers, whose respective sensitivity a second predetermined sensitivity condition as a skipped layer for which training is to be skipped in each of the plural repeated trainings.

5. The method of claim 4, wherein the calculating of the respective maintenance probability of each of the plural layers comprises:
calculating respective maintenance probabilities of each of one or more layers of the plural layers, other than the one or more maintenance layers and the skipped layer, for the t-th repeated training of the machine-learning model; and
setting the respective maintenance probability of each of the one or more maintenance layers a maintenance probability value that satisfies the first predetermined maintenance condition.

6. The method of claim 1, wherein the calculating of the respective maintenance probability of each of the plural layers of the model comprises:
calculating a calibration factor of the t-th repeated training of the model, based on a current throughput of the model and the first maintenance probability of the t-th repeated training of the model; and
calculating the respective maintenance probability of each of the plural layers of the model based on the respective sensitivity of each of the plural layers of the model, the first maintenance probability of the t-th repeated training of the model, and the calibration factor of the t-th repeated training of the model.

7. The method of claim 6, wherein the calculating of the respective maintenance probability of each of the plural layers of the model further comprises:
calculating the first maintenance probability of the t-th repeated training of the model in accordance with:
$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ ,$$
and
wherein θₜ is the first maintenance probability of the t-th repeated training of the model, a is a shape parameter of the model, b is a proportional parameter of the model, c is a binomial weight of the model, t is a training repetition ordinal number, ε is a threshold parameter of the model, η is an amplification factor of the model, θ is a predetermined maintenance probability, and Γ is a gamma function.

8. The method of claim 6, wherein the calculating of the respective maintenance probability of each of the plural layers of the model, based on the respective sensitivity of each of the plural layers of the model, the maintenance probability of the t-th repeated training of the model, and the calibration factor for the t-th repeated training of the model includes calculating the respective maintenance probability of each of the plural layers of the model in accordance with:
p_{t,l}=clamp(αₜ(θₜ+βS_{base}(l)), θₘᵢₙ, θₘₐₓ), and
wherein p_{t,l} is the respective maintenance probability of an l-th layer for the t-th repeated training of the model, αₜ is the calibration factor for the t-th repeated training of the model, θₜ is the first maintenance probability for the t-th repeated training of the model, β is a sensitivity factor, S_{base}(l) is sensitivity of the l-th layer of the model, θₘᵢₙ is a minimum value for the respective maintenance probability of the l-th layer of the t-th repeated training of the model, and θₘₐₓ is a maximum value of the respective maintenance probability of the l-th layer for the t-th repeated training of the model.

9. The method of claim 6, wherein the calculating of the calibration factor for the t-th repeated training of the model, based on the current throughput of the model and the first maintenance probability for the t-th repeated training of the model includes calculating the calibration factor for the t-th repeated training of the model in accordance with:
$${α}_{t} = 2 - ( \frac{T {P}_{c u r r}}{{θ}_{t} + x - {θ}_{t} * x} ) ,$$
and
wherein αₜ is the calibration factor of the t-th repeated training of the model, TP_{curr} is the current throughput of the model, θₜ is the first maintenance probability for the t-th repeated training of the model, and x is a predetermined throughput improvement goal.

10. The method of claim 1, further comprising selecting , comprising:
determining whether an experiment result of a Bernoulli distribution including a respective third maintenance probability of each layer as a parameter is “1”; and
determining a one or more layers having a Bernoulli distribution value corresponding to “1” as a maintenance layer of the one or more maintenance layers.

11. An electronic apparatus, the apparatus comprising:
a processor configured to:
calculate a respective sensitivity of each layer included in a model;
calculate a first maintenance probability for a t-th repeated training of the model;
calculate a respective maintenance probability of each of plural layers of the model based on the respective sensitivity of each of the plural layers and based on the first maintenance probability for the t-th repeated training of the model; and
perform the t-th repeated training of the model including training selected one or more maintenance layers, of the plural layers of the model, whose respective maintenance probabilities satisfy a first predetermined maintenance condition.

12. The apparatus of claim 11, wherein the processor, for the calculating of the respective sensitivity, is configured to calculate sensitivity of an l-th layer based on a first accuracy of the model resulting from the plural layers being trained a predetermined number of times and an accuracy of the model resulting from less than the plural layers, with training of the 1-th layers being skipped, being trained a corresponding predetermined number of times, and
wherein “l” is a positive integer and not greater than a number of layers of the model.

13. The apparatus of claim 11, wherein the processor, for the calculating of the first maintenance probability, is configured to calculate the first maintenance probability of a t-th repeated training of the model based on a related parameter of the model, a training repetition ordinal number “t,” and a predetermined maintenance probability, and
wherein “t” is a positive integer.

14. The apparatus of claim 11, wherein, for the calculation of the respective sensitivities, the processor is further configured to:
determine each first layer, of the plural layers, whose respective sensitivity satisfy a predetermined sensitivity condition as a maintained layer, of the one or more maintenance layers, that is to be maintained for each of plural repeated trainings; and
determine a second layer whose respective sensitivity satisfies a second predetermined sensitivity condition as a skipped layer for which training is to be skipped in each of the plural repeated trainings.

15. The apparatus of claim 14, wherein, for the calculation of the respective maintenance probability, the processor is configured to:
calculate respective maintenance probabilities of each of one or more layers of the plural layers, other than the one or more maintenance layers and the skipped layer, for the t-th repeated training of the model; and
set the respective maintenance probability of each of the maintenance layers, a maintenance probability value that satisfies the first predetermined maintenance condition.

16. The apparatus of claim 11, wherein, for the calculating of the respective maintenance probability, the processor is configured to:
calculate a calibration factor of the t-th repeated training of the model, based on a current throughput of the model and the first maintenance probability; and
calculate the respective maintenance probability of each of the plural layers of the model based on the respective sensitivity of each layer of the model, the first maintenance probability of the t-th repeated training of the model, and the calibration factor of the t-th repeated training of the model.

17. The apparatus of claim 16, wherein, the processor is configured to, for the calculation of the respective maintenance probability of the t-th repeated training of the model, calculate the respective maintenance probability in accordance with:
$${θ}_{t} = \frac{{2}^{( a + c )}}{Γ ( a + c ) {b}^{( a + c )}} {( t - ε )}^{( a + c - 1 )} {e}^{( - 2 * \frac{t - ε}{b} )} \frac{η}{{θ}^{2}} + θ ,$$
and
wherein θₜ is the first maintenance probability, a is a shape parameter of the model, b is a proportional parameter of the model, c is a binomial weight of the model, t is a training repetition ordinal number, ε is a threshold parameter of the model, η is an amplification factor of the model, θ is a predetermined maintenance probability, and Γ is a gamma function.

18. The apparatus of claim 16, wherein the processor is configured to calculate the maintenance probability of each of the plural layers of the model in accordance with:
p_{t,l}=clamp(αₜ(θₜ+βS_{base}(l)), θₘᵢₙ, θₘₐₓ), and
wherein p_{t,l} is the respective maintenance probability, αₜ is the calibration factor for the t-th repeated training of the model, θₜ is the first maintenance probability, β is a sensitivity factor, S_{base}(l) is sensitivity of the l-th layer of the model, θₘᵢₙ is a minimum value for the respective maintenance probability, and θₘₐₓ is a maximum value of the respective maintenance probability.

19. The apparatus of claim 11, wherein the processor is configured to:
determine whether an experiment result of a Bernoulli distribution including a respective third maintenance probability of each layer as a parameter is “1”; and
determine one or more layers having a Bernoulli distribution value corresponding to “1” as a maintenance layer of the one or more maintenance layers.

20. A processor-implemented method, the method comprising:
determining, from among a plurality of layers of a machine-learning model, one or more layers having a sensitivity below a predetermined threshold according to a probability for a t-^{th} repeated training of the machine-learning model;
iteratively training the machine-learning model as t-^{th} repeated training, including skipping training of the one or more layers having the sensitivity below the predetermined threshold; and
training the machine-learning model according to remaining layers, other than the one or more layers whose training is skipped in the t-^{th} repeated training, having sensitivities above the predetermined threshold.
